(19) United States
(12) Patent Application Publication
(10) Pub. No.: US 2019/0009232 A1
(43) Pub. Date: Jan. 10, 2019

(54) Blender for Frac Fluids

(71) Applicant: BJ Services, LLC, Tomball, TX (US)

(72) Inventor: Tony Yeung, Tomball, TX (US)

(73) Assignee: BJ Services, LLC, Tomball, TX (US)

(21) Appl. No.: 16/026,254

(22) Filed: Jul. 3, 2018

Related U.S. Application Data
(60) Provisional application No. 62/530,630, filed on Jul. 10, 2017.

(51) Int. Cl. B01F 15/00; B01F 15/02; B01F 13/00; B01F 3/12; E21B 41/00

(52) U.S. Cl. CPC B01F 15/00292; B01F 15/00149; B01F 15/00142; B01F 15/00272; B01F 15/0251; B01F 15/0037; E21B 43/267; B01F 15/0261; B01F 13/004; B01F 3/1207; E21B 41/00; B01F 2215/0081; B01F 15/0243

(57) ABSTRACT

The density of slurries produced by mobile blender for injection into oil and gas wells is controlled using a microwave flow meter. Liquid having a known density is provided to the blender. The liquid is flowed through a conduit and discharged into a blending tub on the mobile blender. The amount of liquid introduced into the tub is measured with a liquid flow meter. Solid particulates having a known density are provided to the blender. The particulates are discharged into the tub by allowing them to fall into the tub from a conveyor on the mobile blender. The amount of the particulates falling into the tub are measured with a microwave flow meter. The flow of the liquid and the particulates are controlled in response to the measurements to blend a slurry having a predetermined density. The slurry is provided for injection into the well.

### FIELD OF THE INVENTION

The present invention relates to systems for preparing fluids used in fracturing operations for oil and gas wells, and more particularly, to blenders for mixing liquid and solid particulates together to prepare a fracturing fluid with suspended particulates.

### BACKGROUND OF THE INVENTION

Hydrocarbons, such as oil and gas, may be recovered from various types of subsurface geological formations. The formations typically consist of a porous layer, such as limestone and sands, overlaid by a nonporous layer. Hydrocarbons cannot rise through the nonporous layer. Thus, the porous layer forms a reservoir, that is, a volume in which hydrocarbons accumulate. A well is drilled through the earth until the hydrocarbon bearing formation is reached. Hydrocarbons then can flow from the porous formation into the well.

In what is perhaps the most basic form of rotary drilling methods, a drill bit is attached to a series of pipe sections referred to as a drill string. The drill string is suspended from a derrick and rotated by a motor in the derrick. A drilling fluid or “mud” is pumped down the drill string, through the bit, and into the well bore. This fluid serves to lubricate the bit and carry cuttings from the drilling process back to the surface. As the drilling progresses downward, the drill string is extended by adding more pipe sections.

When the drill bit has reached the desired depth, larger diameter pipes, or casing, are placed in the well and cemented in place to prevent the sides of the borehole from caving in. The well may be extended by drilling additional sections and installing large, but somewhat smaller pipes, or liners. The liners also are typically cemented in the bore. The liner may include valves, or it may then be perforated. In either event, openings in the liner are created through which oil can enter the cased well. Production tubing, valves, and other equipment are installed in the well so that the hydrocarbons may flow in a controlled manner from the formation, into the lined well bore, and through the production tubing up to the surface for storage or transport.

Hydrocarbons, however, are not always able to flow easily from a formation to a well. Some subsurface formations, such as sandstone, are very porous. Hydrocarbons can flow easily from the formation into a well. Other formations, however, such as shale rock, limestone, and coal beds, are only minimally porous. The formation may contain large quantities of hydrocarbons, but production through a conventional well may not be commercially practical because hydrocarbons flow though the formation and collect in the well at very low rates. The industry, therefore, relies on various techniques for improving the well and stimulating production from formations. In particular, various techniques are available for increasing production from formations which are relatively nonporous.

Perhaps the most important stimulation technique is the combination of horizontal well bores and hydraulic fracturing. A well will be drilled vertically until it approaches a formation. It then will be diverted, and drilled in a more or less horizontal direction, so that the borehole extends along the formation instead of passing through it. More of the formation is exposed to the borehole, and the average distance hydrocarbons must flow to reach the well is decreased. Fractures then are created in the formation which will allow hydrocarbons to flow more easily from the formation.

Fracturing a formation is accomplished by pumping fluid, most commonly water, into the well at high pressure and flow rates. Proppants, such as grains of sand, ceramic or other particulates, usually are added to the fluid along with gelling agents to create a particulate-laden slurry. The slurry is forced into the formation at rates faster than can be accepted by the existing pores, fractures, faults, vugs, caverns, or other spaces within the formation. Pressure builds rapidly to the point where the formation fails and begins to fracture. Continued pumping of fluid into the formation will tend to cause the initial fractures to widen and extend further away from the well bore, creating flow paths to the well. The proppant serves to prevent fractures from closing when pumping is stopped.

A formation rarely will be fractured all at once. It typically will be fractured in many different locations or zones and in many different stages. Fluids will be pumped into the well to fracture the formation in a first zone. After the initial zone is fractured, pumping is stopped, and a plug is installed in the liner at a point above the fractured zone. Pumping is resumed, and fluids are pumped into the well to fracture the formation in a second zone located above the plug. That process is repeated for zones further up the formation until the formation has been completely fractured.

Systems for successfully completing a fracturing operation, therefore, are extensive and complex, as may be appreciated from FIG. 1. Water from tanks 1 and gelling agents dispensed by a chemical unit 2 are mixed in a hydration unit 3. The discharge from hydration unit 3, along with sand carried on conveyors 4 from sand tanks 5 is fed into a blending unit 6. Blender 6 mixes the gelled water and sand into a slurry. The slurry is discharged through low-pressure hoses 7 which convey it into two or more low-pressure lines 8 in a frac manifold 9. The low-pressure lines 8 in frac manifold 9 feed the slurry to an array of pumps 10, perhaps as many as a dozen or more, through low-pressure “suction” hoses 11.

Pumps 10 take the slurry and discharge it at high pressure through individual high-pressure “discharge” lines 12 into two or more high-pressure lines or “missiles” 13 on frac manifold 9. Missiles 13 flow together, i.e., they are manifolded on frac manifold 9. Several high-pressure flow lines 14 run from the manifolded missiles 13 to a “goat head” 15. Goat head 15 delivers the slurry into a “zipper” manifold 16 (also referred to by some as a “frac manifold”). Zipper manifold 16 allows the slurry to be selectively diverted to, for example, one of two well heads 17. Once fracturing is complete, flow back from the fracturing operation discharges into a flowback manifold 18 which leads into flowback tanks 19.

Because frac systems are required on site for a relatively short period of time, the larger components of a frac system typically are transported to a well site on skids, trailers, or trucks as more or less self-contained units. They then are connected to the system by one kind of conduit or another. In FIG. 1, for example, chemical unit 2, hydration unit 3, and blender 6 are illustrated schematically as mounted on a trailer which is transported to the well site by a truck. Because they are designed to be more or less self-contained units, however, they are complex machines and incorporate several distinct subsystems and a large number of individual components. Moreover, they must be transported over public highways, and regulatory requirements as a practical matter impose fairly severe spatial and weight constraints. Accommodating all that equipment within such constraints can be challenging, especially given the need to ensure that the unit may be efficiently and economically maintained and serviced.

Blender unit 6, for example, is illustrated schematically in FIG. 1 and performs what may appear to be a relatively simple function mixing solid particulates into a liquid. Yet even when described at a high level of abstraction it is an incredibly complex machine. Gelled water or other frac liquid is fed into blender 6 from hydration unit 2 via a number of suction hoses (not shown). The suction hoses from hydration unit 2 connect to a series of connections on blender 6, what is typically referred to as the suction bank. The connections on the suction bank are manifolded into a line which feeds the liquid into a mixing tub. The dry solids from sand tanks 5 typically are fed into a bin on blender 6, from whence they are dispensed into the tub by augers. The tub typically will have paddles or other mixing blades that are rotated to thoroughly blend the liquid and solids into a slurry. A discharge line conveys the slurry from a drain in the tub to a dividing manifold which terminates in a number of connections, the “discharge bank.” Hoses then convey the slurry from the discharge bank to frac manifold 9.

Pumps, typically centrifugal pumps, are provided on both the suction and the discharge side of blender 6 to pump the fluid into the mixing tub and to pump the slurry out the discharge bank. Power units, typically a pair of diesel engines, also are provided to drive the suction and discharge pumps, and to drive the mixing blades in the tub. The engines may power the pumps, mixers, and other components either directly, through mechanical drive systems, or indirectly, through hydraulic systems or electric generators. Blender 6 also includes various systems to monitor and control the unit.

Blender 6 typically is the last stage in preparing a frac slurry for pumping into a well. It is important, therefore, that the density of the slurry prepared by blender 6 be continually monitored and controlled so that it meets specifications for the fracturing operation. Radioactive densitometers typically are used to provide density measurements. They are capable of measuring the density of fluids which are entrained with solids. As their name implies, however, they incorporate radioactive materials which are inherently hazardous. Moreover, they must be calibrated fairly closely, and may be inaccurate if flow rates and target densities vary from those at which the instrument was calibrated.

While the liquid flowing into the blender is essentially free of solids, that is not true of the slurry draining out of the mixing tub. It typically will be heavily laden with abrasive solids, and thus, the discharge lines leading from the tub are susceptible to much greater wear than the suction side of the blender. The discharge bank in particular has many right-angle, tee junctions, typically formed by welded or “stab in” connections, which lead to the discharge connections. The slurry flow in that area is quite turbulent and can rapidly erode the discharge bank.

Dry solids fed into the mixing tub also can drag air into the fluid. The suspension agents used to keep solids from settling also will tend to stop air bubbles from flowing up and out of the fluid. Fluid draining from the tub also will tend to form a vortex as it flows toward the discharge pump. Air entrained in liquid, and especially vortexes entering a centrifugal pump can significantly impair the pump's performance and can damage it. Thus, the main drain line leading from the tub to the discharge pump typically is provided with a vortex breaker. The breaker usually is one or more straight bars extending normally, that is, perpendicularly across the slurry flow. Such vortex breakers are particularly susceptible to erosion, especially at their junction with the internal walls of the drain line.

Mechanical drive trains may be used to power the tub and blender pumps. They generally are more efficient that powering those units with hydraulic systems. On the other hand, especially when they are used to drive the discharge pump, the drive train may be subject to a high level of mechanical shock when the engine's transmission is engaged and power is supplied to the drive train. The engine is operating at high rpms, the rotation of the engine is stepped up by a gear box, and there is a large, and essentially incompressible head of fluid in and above the pump. That shock place enormous stress on the drive train components which can reduce their service life.

Diesel engines used to provide power to the blender generally are highly reliable. Nevertheless, they are subject to heavy and prolonged service fracturing operations may continue nearly continuously over the course of several days. The engines necessarily will require regular maintenance and service. Infrequently they will require major repair. The spatial constraints imposed by the trailer, and the manner in which the engine is configured and mounted, however, may not always make such service and repair easy.

The statements in this section are intended to provide background information related to the invention disclosed and claimed herein. Such information may or may not constitute prior art. It will be appreciated from the foregoing, however, that there remains a need for new and improved blenders for frac fluids and methods for blending frac fluids. Such disadvantages and others inherent in the prior art are addressed by various aspects and embodiments of the subject invention.

### SUMMARY OF THE INVENTION

The subject invention, in its various aspects and embodiments, relates generally to blender units used in fluid transportation systems and, especially, in frac systems to mix liquid and solid particulates. It encompasses various embodiments and aspects, some of which are specifically described and illustrated herein.

One broad embodiment and aspect of the subject invention provides methods for controlling the density of a slurry for injection into a well as the slurry is blended by a mobile blending apparatus using a microwave flow meter to measure the flow of solid particulates.

Other embodiments provide such methods where liquid having a known density is provided to the blender. The liquid is flowed through a conduit and discharged into a blending tub on the mobile blender. The amount of liquid introduced into the tub is measured with a liquid flow meter. Solid particulates having a known density are provided to the blender. The particulates are discharged into the tub by allowing them to fall into the tub from a conveyor on the mobile blender. The amount of the particulates falling into the tub are measured with a microwave flow meter. The flow of the liquid and the particulates are controlled in response to the measurements to blend a slurry having a predetermined density. The slurry is provided for injection into the well.

Yet other embodiments provide methods where the liquid is measured using a magnetic resonance or turbine flow meter.

Additional embodiments provide methods where the conveyor is a screw auger and the flow of the particulates is controlled by varying the speed of the auger. Other embodiments provide methods where the conveyor discharges the particulates through a gravity flow metering device and the flow of the particulates is controlled by adjusting the device.

Still other embodiments provide methods where the mobile blender comprises a centrifugal pump in the conduit and the flow of the liquid is controlled by varying the speed of the pump. Other embodiments provide methods where the conduit comprises a flow control valve and the flow of the liquid is controlled by adjusting the valve.

Another broad embodiment and aspect of the subject invention provides blenders, especially trailer or skid mounted blenders, which measure and determine the density of produced slurry by using a flow meter, such as a magnetic resonance or turbine flow meter, to measure the quantity of fluids introduced into the slurry in combination with a microwave flow meter to measure the quantity of solids introduced into the slurry.

Other embodiments provide mobile apparatus for blending liquid and particulates into a slurry. The blender comprises a chassis, a blending tub, a suction system, a solids system, and a controller. The blending tub is mounted on the chassis. The suction system is adapted to discharge liquid into the tub and comprises a flow meter. The flow meter is adapted to measure the flow of liquid through the suction system. The solids system is adapted to discharge solid particulates into the tub and comprises a conveyor and a microwave flow meter. The microwave flow meter is adapted to measure the flow of particulates discharged by the conveyor as the particulates fall into the tub. The controller is operatively connected to the suction system, the flow meter, the solids system, and the microwave flow meter. It is adapted to control the rate of liquid and solids discharged into the tub by, respectively, the suction system and the solids system in response to input from the liquid flow meter and the microwave flow meter to produce a slurry having a predetermined density.

Yet other embodiments provide mobile blenders were the suction system comprises a suction line adapted to convey fluid into the tub and a pump adapted to pump fluid through the suction line. The flow meter is provided in the suction line. The controller is operatively connected to the pump and is adapted to control the rate of liquid discharged into the tub by controlling the speed of the pump.

Still other embodiments provide mobile blenders where the suction system comprises a suction line adapted to convey fluid into the tub, a pump adapted to pump fluid through the suction line, and a flow control valve. The flow meter and the flow control valve are provided in the suction line. The controller is operatively connected to the flow control valve and is adapted to control the rate of liquid discharged into the tub by adjusting the flow control valve.

Additional embodiments provide mobile blenders where the controller is operatively connected to the conveyor and is adapted to control the rate of solids discharged into the tub by controlling the speed of the conveyor.

Other embodiments provide mobile blenders where the solids system comprises a gravity flow metering device adapted to receive the discharge from the conveyor. The controller is operatively connected to the metering device and is adapted to control the rate of solids discharged into the tub by adjusting the metering device.

Yet other embodiments provide mobile blenders where the solids system comprises a discharge chute having surfaces adapted to guide the flow of the particulates proximate to the microwave flow meter and mobile blenders where the chute is mounted below the discharge end of the conveyor and above the tub such that particulates discharged from the conveyor fall through the chute and into the tub.

Further embodiments provide mobile blenders where the solids system comprises a plurality of conveyors. The chute comprises an open receiving portion adapted to receive the particulates discharged by the plurality of conveyors and guide the particulates into a plurality of outlet ducts. A microwave flow meter is mounted in each outlet duct.

Still other embodiments provide mobile blenders where the liquid flow meter is a magnetic resonance or a turbine flow meter.

Other embodiments provide mobile blenders where the blender is mounted on a rolling chassis.

Other embodiments and aspects of the invention provide systems for introducing solid particulates into a mixing tub on a mobile apparatus that blends liquid and particulates into a slurry. The solids system comprises a supply bin, a conveyor, and a baffle. The conveyor is mounted on the mobile blender and adapted to transport the particulates from a receiving end communicating with the supply bin to a discharge end elevated above the tub. The baffle is mounted below the discharge end of the conveyor and above the tub such that particulates discharged from the conveyor fall on the baffle and then into the tub. The baffle also is adapted to divide the particulates into a plurality of streams.

Additional embodiments provide solids system where the baffle is a plate having a plurality of openings, where the openings in the baffle plate are obround, and where the openings are arranged in offset, linear arrays.

Still other embodiments provide solids systems where the baffle comprises a plate mounted at an angle such that the openings are situated at a plurality of elevations and the particulates discharged onto the baffle plate are directed downward across the plate.

Further embodiments provide solids systems where the baffle comprises a chute mounted under the conveyor discharge end and having surfaces adapted to guide the flow of the particulates onto the baffle plate.

Yet other embodiments provide solids systems where the conveyor is a screw auger.

Still other embodiments provide mobile blenders comprising the solids system.

Another broad embodiment provides blenders, especially trailer or skid mounted blenders, which comprise modular manifold and connection banks. The blender preferably includes modular manifolds and connections banks on both its suction and it discharge side. Preferably, the modular manifolds and connection banks on both sides are identical and interchangeable. They preferably are mounted via brackets and secured by strapping to allow easy assembly to and disassembly from the blender.

Other embodiments and aspects of the subject invention provide mobile apparatus for blending liquid and particulates into a slurry. The blender comprises a suction bank, a suction line, a blending tub, a discharge line, and a discharge bank. The suction bank comprises a plurality of connectors adapted to provide a union to a feed hose. The connectors communicate with a combining manifold. The suction line communicates with the combining manifold of the suction bank. The blending tub is adapted to receive fluid from the suction line and particulates and blend the fluid and the particulates into a slurry. The discharge line communicates with the blending tub. The discharge bank communicates with the discharge line. The discharge bank comprises a dividing manifold and a plurality of connectors adapted to provide a union with a discharge hose. The combining manifold of the suction bank or the dividing manifold of the discharge bank comprises a plurality of pipe segments. Each pipe segment is adapted for assembly to another pipe segment and comprises at least one connector, but typically a plurality of connectors.

Still other embodiments provide blenders where the combining manifold of the suction bank and the dividing manifold of the discharge bank each comprise a plurality of pipe segments. Each pipe segment is adapted for assembly to another pipe segment and comprises at least one the connector, but typically a plurality of connectors.

Additional embodiments provide blender where the pipe segments of the combining manifold of the suction bank and the pipe segments of the dividing manifold of the discharge bank are interchangeable.

Other embodiments provide blenders where the pipe segments are joined by flange unions and blenders where the suction bank connectors or the discharge bank connectors are hammer union subs.

Yet other embodiments provide blenders where the combining manifold of the suction bank or the dividing manifold of the discharge bank are supported on brackets mounted on a chassis.

Further embodiments provide blenders where the blender is mounted on a rolling chassis.

Other embodiments and aspects of the subject invention provide mobile apparatus for blending liquid and particulates into a slurry. The blender comprises a frame, and a plurality of brackets. The discharge system comprises a pump, a discharge line, and a discharge bank. The discharge line is connected to the pump and has a section running laterally along the blender. The discharge bank runs laterally along the blender. The brackets extend from the frame and support the lateral section of the discharge line and the discharge bank for lateral movement therein.

Yet other embodiments provide blenders where the lateral section of the discharge line and the discharge bank run substantially parallel to each other and are connected by a section of the discharge line running vertically across the blender.

Additional embodiments provide blenders where the lateral section of the discharge line and the discharge bank are releasably secured on the brackets by straps.

Other aspects and embodiments of the subject invention provide mobile apparatus for blending liquid and particulates into a slurry. The blender comprises a frame, a suction system, and a plurality of brackets. The suction system comprises a suction bank, a pump, and a suction line. The suction bank runs laterally along the blender. The suction line is connected to the pump and has a section running laterally along the blender. The brackets extend from the frame. The brackets support the lateral section of the suction line and the suction bank for lateral movement therein.

Still other embodiments provide blenders where the suction bank and the lateral section of the suction line run substantially parallel to each other.

Additional embodiments provide blenders where the lateral section of the suction line and the suction bank are releasably secured on the brackets by straps.

Still other embodiments provide blenders, especially trailer or skid mounted blenders, which comprise novel vortex breakers. The novel vortex breakers may be mounted in the drain line leading from the mixing tub. One novel vortex breaker comprises fin members. The fins preferably are shaped like an isosceles trapezoid. They abut each other at their bases and project radially outward from the center of the drain line. The fins are angularly arrayed about an axis defined by their abutting bases. The tops of the fins are joined to the inner wall of drain line. The fins thus come to a point at each end, with one end pointing upstream against the direction of flow through the drain line. The other end points downstream along the flow.

Other novel breakers may include a conduit having a rectilinear portion, that is, a portion with a generally rectilinear cross-section. The conduit preferably has cylindrical portions on both sides of the rectilinear sections.

In other aspects and embodiments, the invention provides for blenders, especially trailer or skid mounted blenders, that comprise a drive train mechanically coupling an engine and a pump or another blender component. The drive train includes a first drive shaft coupling a transmission to a gear box. A second drive shaft couples the gear box to the pump or other blender component. Preferably, the gear box is remote from the transmission, and is independently mounted on shock absorbing mounts.

Yet other embodiments provide blenders, especially trailer or skid mounted blenders, that have a cooling system. The blender comprises a pair of internal combustion engines. The cooling system comprises two radiators, each radiator being fluidly connected to only one of the engines. A single air mover is used to direct air flow over both radiators.

Additional embodiments of the invention provide blenders, especially trailer or skid mounted blenders, where the discharge pump is controlled to maintain a specified hydraulic pressure in the discharge lines. The specified pressure preferably corresponds to the pressure head required by the frac pumps. The blender comprises a pressure sensor such as a pressure transducer. The pressure sensor is mounted downstream of the discharge pump. The sensor is connected to a programmable logic controller or another conventional digital computer system which then will control the speed of the discharge pump by suitable control systems in response to the pressure data.

Other embodiments and aspects of the subject invention provide methods of controlling the flow of slurry comprising particulates suspended in liquid from a mobile blending apparatus for supply to an array of frac pumps. The method comprises operating a pump on the mobile blending apparatus to pump the slurry through a discharge line on the mobile blender for supply to the frac pumps. The hydraulic pressure in the discharge line is measured. The speed of the pump is controlled in response to the pressure measurements to maintain the hydraulic pressure in the discharge line at a predetermined level corresponding to the pressure head required for proper operation of the pumps.

Still other embodiments and aspects of the subject invention provide mobile apparatus for blending liquid and particulates into a slurry. The blender comprises a chassis, a blending tub, a discharge system, and a controller. The blending tub is mounted on the chassis. The discharge system is adapted to convey the slurry from the tub for supply to an array of frac pumps. The discharge system comprises a pump, a discharge line, and a pressure sensor. The discharge line is downstream of the pump. The pressure sensor is provided in the discharge line and is adapted to measure the hydraulic pressure in the discharge line. The controller is operatively connected to the pump and the pressure sensor. The controller is adapted to control the speed of the pump in response to input from the pressure sensor to maintain a predetermined hydraulic pressure in the discharge line.

Finally, still other aspects and embodiments of the invention will have various combinations of such features as will be apparent to workers in the art.

Thus, the present invention in its various aspects and embodiments comprises a combination of features and characteristics that are directed to overcoming various shortcomings of the prior art. The various features and characteristics described above, as well as other features and characteristics, will be readily apparent to those skilled in the art upon reading the following detailed description of the preferred embodiments and by reference to the appended drawings.

Since the description and drawings that follow are directed to particular embodiments, however, they shall not be understood as limiting the scope of the invention. They are included to provide a better understanding of the invention and the manner in which it may be practiced. The subject invention encompasses other embodiments consistent with the claims set forth herein.

### BRIEF DESCRIPTION OF THE DRAWINGS

FIG. 1 (prior art) is a schematic view of a system for fracturing a well and receiving flow back from the well, which system includes a conventional blender 6.

FIG. 2 is an isometric view, taken generally from one side and above, of a preferred embodiment 100 of the novel blender units of the subject invention which shows the “suction” side of blender 100.

FIG. 3 is an isometric view, similar to the view of FIG. 1 except that it is taken from the other side, of blender 100 showing its “discharge” side.

FIG. 4 is an enlarged isometric view taken from the suction side of blender 100 showing suction system 34 of blender 100.

FIG. 5 is an enlarged view of the suction side of blender 100 having suction system 34 removed to show suction bracket system 25 for mounting suction system 34.

FIG. 6 is an enlarged isometric view taken from the discharge side of blender 100 showing discharge system 60 of blender 100 and portions of mixing system 40 and power system 70.

FIG. 7 is another enlarged isometric view, similar to the isometric view of FIG. 6 except that it is taken somewhat below blender 100, showing portions of discharge system 60 and power system 70.

FIG. 8 is another enlarged isometric view from the discharge side of blender 100 having discharge system 60 removed, which view shows portions of power system 70 and discharge bracket system 26 for mounting discharge system 60.

FIG. 9 is an isometric view showing, in isolation, solids system 50 used in blender 100.

FIG. 10 is an isometric view showing, in isolation, another preferred solids system 150 that may be used in blender 100.

FIG. 11 is another isometric view, taken from in front and below, of solids system 150.

FIG. 12A is an axial cross-sectional view of a first novel vortex breaker 80 which may be incorporated into blender 100.

FIG. 12B is a lateral cross-sectional view of vortex breaker 80 shown in FIG. 12A.

FIG. 13A is an axial cross-sectional view of a second novel vortex breaker 85 which may be incorporated into blender 100.

FIG. 13B is a lateral cross-sectional view of vortex breaker 85 shown in FIG. 13A.

FIG. 14 is a schematic view of portions of power system 70 illustrating a novel cooling system 90 for engines 71 of power system 70.

In the drawings and description that follows, like parts are identified by the same reference numerals. The drawing figures are not necessarily to scale. Certain features of the embodiments may be shown exaggerated in scale or in somewhat schematic form and some details of conventional design and construction may not be shown in the interest of clarity and conciseness.

### DESCRIPTION OF ILLUSTRATIVE EMBODIMENTS

The invention, in various aspects and embodiments, is directed generally to blender units used in fluid transportation systems, and especially to systems that are used to prepare and convey abrasive, corrosive fluids as are employed in temporary systems for oil and gas well fracturing operations. Various specific embodiments will be described below. For the sake of conciseness, all features of an actual implementation may not be described or illustrated. In developing any actual implementation, as in any engineering or design project, numerous implementation-specific decisions must be made to achieve a developers' specific goals. Decisions usually will be made consistent within system-related and business-related constraints, and specific goals may vary from one implementation to another. Development efforts might be complex and time consuming and may involve many aspects of design, fabrication, and manufacture. Nevertheless, it should be appreciated that such development projects would be a routine effort for those of ordinary skill having the benefit of this disclosure.

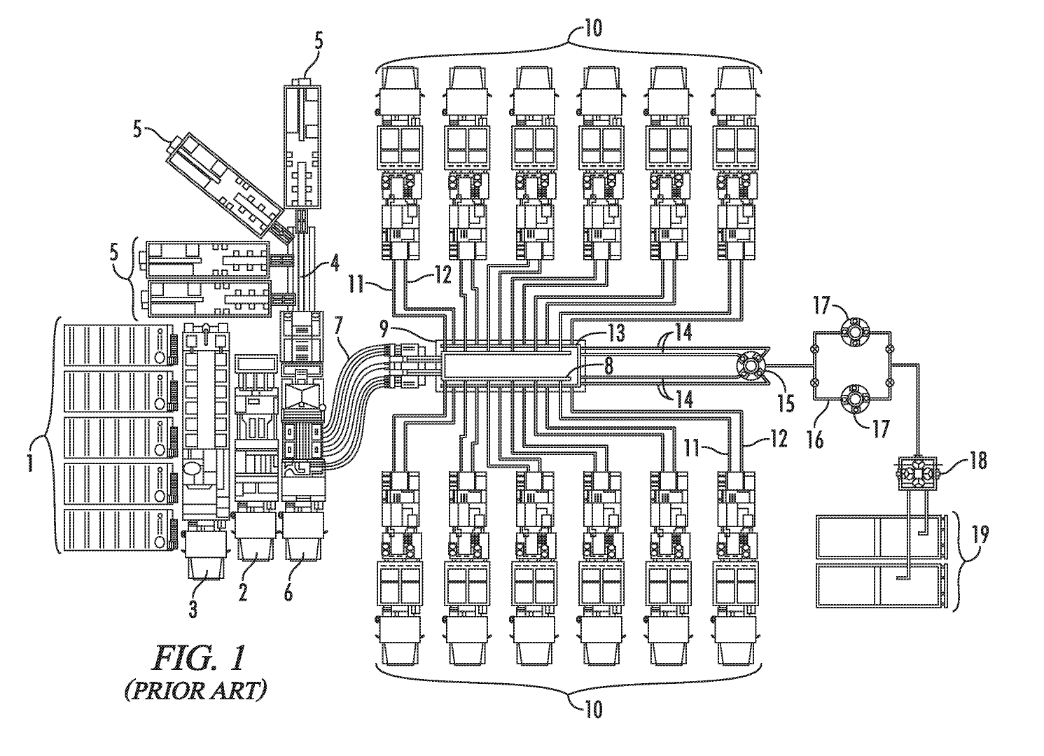

The novel blender units typically will be used in temporary fluid transportation systems. They are particularly useful for temporary installations that must be assembled and disassembled on site and which may be installed at one site and then another. Such systems are common in chemical and other industrial plants, on marine dredging vessels, strip mines, and especially in the oil and gas industry. Frac systems, such as those shown in FIG. 1, are a very common application where temporary fluid transportation systems are routinely assembled and disassembled at various sites to fracture different wells.

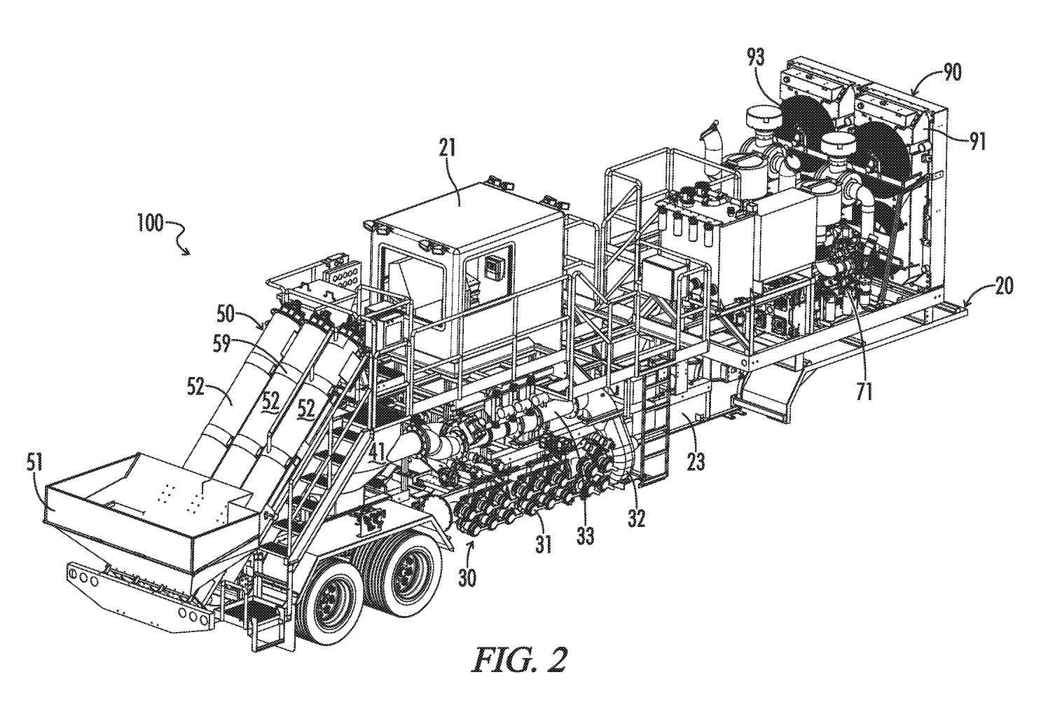

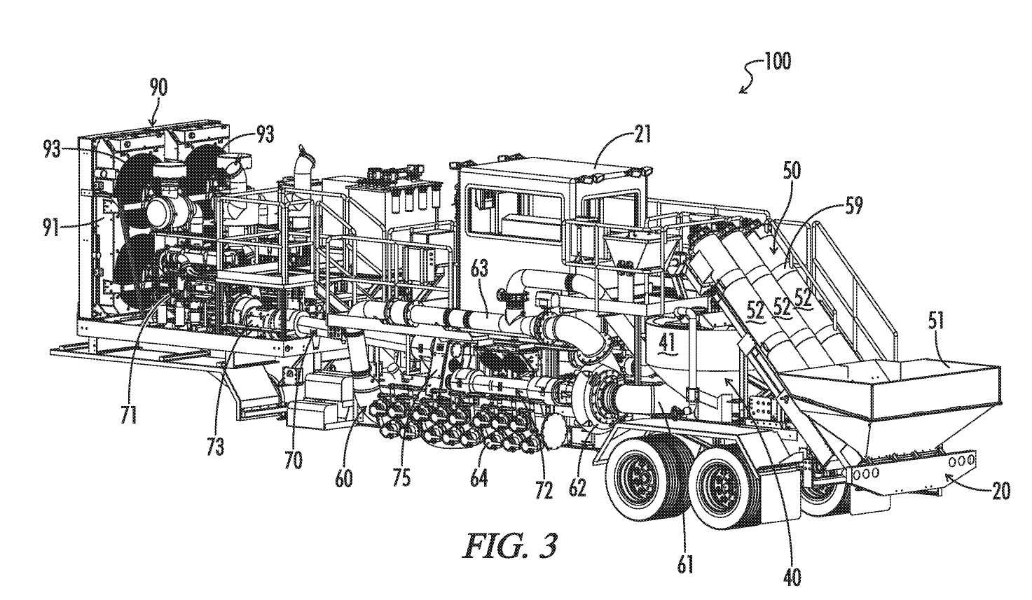

A preferred embodiment 100 of the novel blenders is shown generally in FIGS. 2-3. Blender 100 is particularly suited for use in frac systems such as the system shown in FIG. 1. Blender 100 is mounted on a trailer 20. Trailer 20 is a conventional trailer and generally comprises a frame 23 upon which the various components of blender 100 will be mounted, either directly or indirectly. It also comprises wheels, axels, and a suspensions system, and a hook up mechanism allowing it to be hitched to a truck or other vehicle. Typical safety systems and accessories also will be provided on trailer 20. The interface for various conventional control systems will largely be provided in a cabin 21 mounted on trailer 20. Ladders and platforms also will be provided to allow access to various operational components.

Such features and others are well known in trailers of this type and may be employed as required or desirable. Likewise, while blender 100 is mounted on a rolling chassis such as trailer 20, the novel blenders may be carried on the chassis of a truck. They also may be mounted on a non-rolling chassis such as a skid which may be transported to and from a well site.

Blender 100, as best appreciated from FIGS. 1-2, generally comprises a suction system 34, a mixing system 40, a solids system 50, a discharge system 60, and a power system 70. The primary function of suction system 34 is to receive the liquid phase of frac fluids, such as gelled water, from a hydration unit, such as hydration unit 3 shown in FIG. 1, and deliver it to mixing system 40.

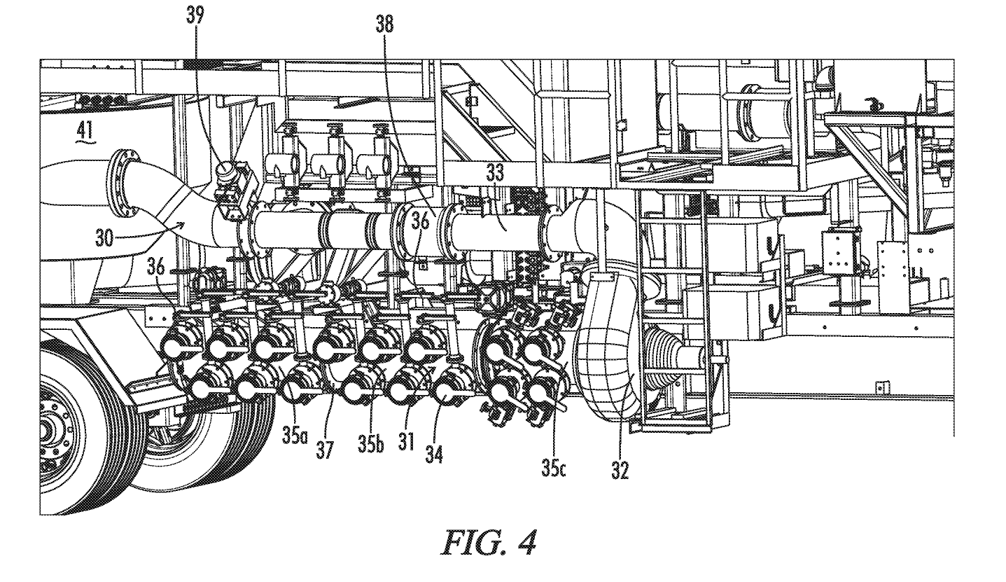

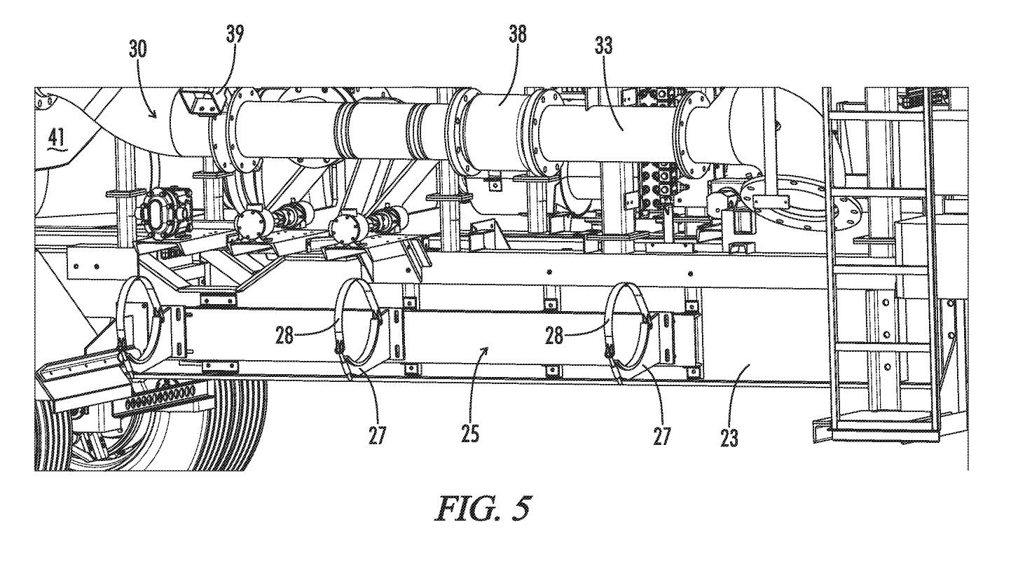

Suction system 34, as seen best in FIGS. 4-5, generally comprises a suction bank 31, a suction pump 32, and a main suction line 33. Fluid from hydration unit 3 (or from multiple hydration units) will be fed into blender 100 via a number of hoses. Thus, suction bank 31 comprises a plurality of hose connections 34 feeding into a combining manifold 35.

Connections 34 preferably are hammer union subs which allow a union to be made up quickly and easily with a hose carrying a mating union sub. They are connected to manifold 35 via flanged butterfly valves 36 that allow each connection to be opened and closed. For transport, as shown in FIG. 4, connections 34 will be provided with a cover to prevent damage to the hammer union sub. It also will be noted that manifold 35 comprises modular units 35a, 35b, and 35c. Manifold units 35a-35c may be joined, for example, by flange unions 37.

Suction bank 31 and manifold 35 preferably, as exemplified, run generally laterally along trailer 20. Manifold 35 feeds into and is connected to suction pump 32. Suction pump 32 typically will be a centrifugal pump. It preferably will be connected to a conventional automatic motor controller to control the speed of the pump. Liquid introduced though suction bank 31 will be pumped by suction pump 32 through a short vertical section into main suction line 33. Main suction line 33 runs generally laterally along trailer 20 above and generally parallel to manifold 35. As exemplified, main suction line 33 may be made up of several shorter pipes joined, for example, by flange or threaded unions. It is connected to and discharges into mixing system 40 and, more particularly, into a tub 41.

The suction systems of the novel blenders may be mounted to a chassis in any conventional manner, such as by bolting or welding it to components of frame 23 of trailer 20. Preferably, however, they will be mounted such that they may be quickly and easily installed and removed as needed. More preferably, they will be supported by a mounting system that allows some translation relative to the chassis while the components are loosely assembled to the chassis.

For example, in FIG. 5 suction system 34 has been removed in large part to show a mounting system 25 for suction manifold 35 of suction system 34. As appreciated therefrom, manifold 35 is supported on brackets, such as saddle mounts or cradles 27, that are affixed to frame 23 of trailer 20. Manifold 35 may be secured in cradles 27 with retainers, such as straps 28 that are connected to cradles 27 with conventional connectors, such as threaded connectors. It will be appreciated that main suction line 33 preferably is mounted on a similar mounting system having cradles and straps.

It will be appreciated, therefore, that when straps 28 are loose, manifold 35 and main suction line 33 may slid laterally within cradles 27 along trailer 20. Moreover, suction bank 31 and main suction line 33 run substantially parallel to each other. That arrangement makes installation and service much easier than, for example, many bolt-on systems. For example, once disconnected from tub 41 the entire suction system 34 may be shifted as a unit laterally along trailer 20. If a particular component needs repair or replacement, the rest of the system may be shifted laterally. Moreover, because they and their components may be shifted laterally as a whole or individually, the components of suction line 31 and manifold 35 may be assembled with flange unions. Flange unions provide a robust seal and connection between components, but require the components to be backed off first so that threaded studs on one component may be inserted through corresponding openings in a flange of the other component.

Moreover, in the event repairs are needed, such systems are better able to accommodate imprecision. For example, if a repair is needed to a portion of suction line 33, it will not be critical that a replacement section match exactly the length of the portion that has been removed. Any differences between the worn portion and its replacement may be made up by moving the rest of discharge system 34 laterally within mounts 25.

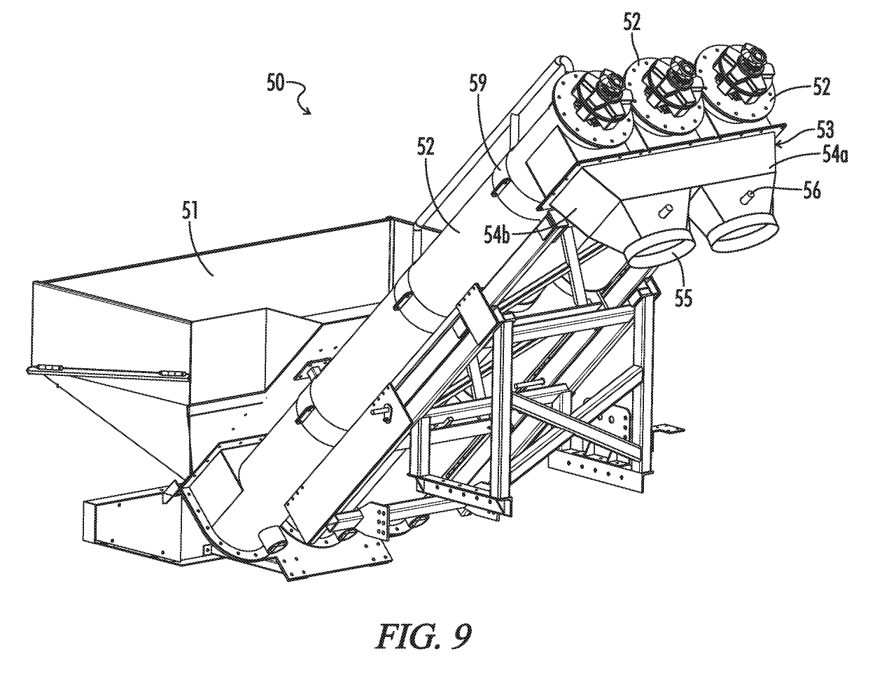

The primary function of solids system 50 is to receive solids, such as sand or other proppants, supplied, for example, via sand conveyers 4 from sand tanks 5, and feed the solids into mixing system 40. Thus, as seen best in FIGS. 2-3, solids system 50 comprises a bin 51 and a conveyor, such as screw-type augers 52. Solids from conveyers 4 are dumped into bin 51. The lower or receiving ends of augers 52 extend toward the bottom of bin 51 and the upper or discharge ends extend over and beyond the lip of tub 41. As augers 52 rotate, solids will be carried up from bin 41 and will fall into tub 41. Augers 52, as is typical in the art, preferably will be connected to automatic motor controllers to control the speed at which they rotate. As seen best in FIG. 9, augers 52 preferably will discharge solids into a discharge chute 53 that will guide the solids into tub 41.

Conventional solid particulate conveyors other than augers, however, may be used if desired. It also will be appreciated that solids system 50 preferably will be mounted on a carriage or similar sub-frame that will allow it to be moved, for example, by hydraulic pistons. Solids system 50 thus may be moved into an operational position, in which it is positioned to discharge into tub 41, or into a transport position, where it is moved forward and tucked into trailer 20 to provide a more compact unit. Solids system 50 is illustrated in FIGS. 2-3 in its transport position.

Mixing system 40 primarily serves to ensure that the liquid phase supplied through suction system 34 and the particulates supplied through solids system 50 are thoroughly blended into a homogeneous slurry. Tub 41, therefore, is provided with various paddles and mixing blades (not shown). Various designs for such mixers are known and may be used as desired. Tub 41 preferably is mounted to frame 23 with bolt-on slides having oval through-holes to allow some flexibility in positioning tub 41 on trailer 20. Many conventional designs for slide mounts are known and may be used.

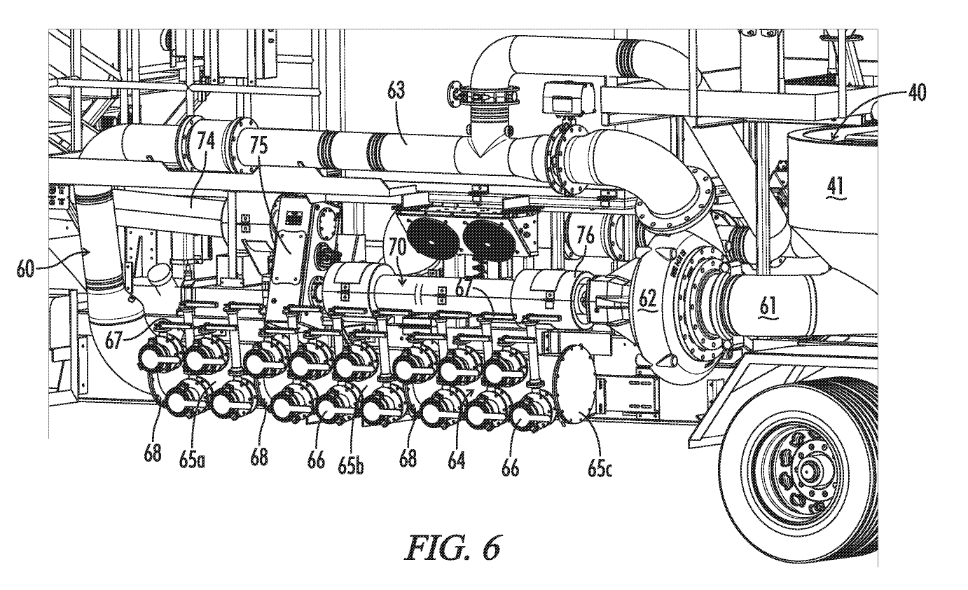

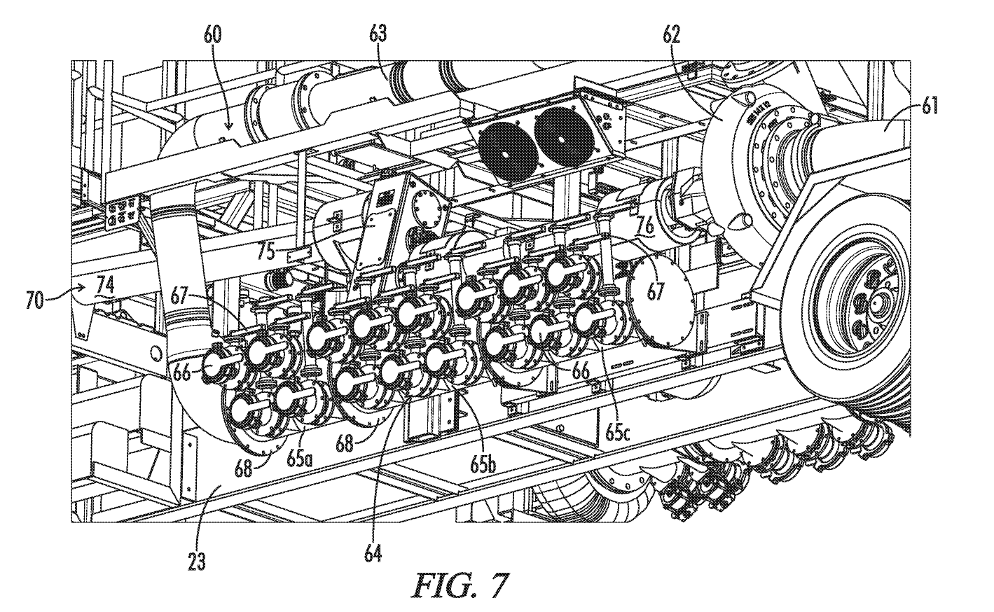

Discharge system 60 primarily serves to accept slurry from tub 41 and convey the slurry into hoses leading to, for example, frac manifold 9. Thus, as seen best in FIGS. 6-7, discharge system 60 generally comprises a drain line 61, a pump 62, a main discharge line 63, and a discharge bank 64. Slurry draining from tub 41 flows through drain line 61 leading to pump 62. Discharge pump 62, like suction pump 32, preferably is a centrifugal pump and will be connected an automatic controller. Pump 62 pumps the slurry through a short vertical section of discharge line 63. The major portion of discharge line 63 runs laterally along trailer 20 before turning down and trailer 20. It then connects with discharge bank 64 which also runs laterally along trailer 20 and generally parallel to discharge line 63.

It will be appreciated by workers in the art that fluids used in a fracturing operation are carefully designed for a particular formation and for the pattern of fractures that will be created. Among many others, one of the more important factors is the density of the frac fluid. The fluid's density will determine the weight of the fluid column in the well and will provide a component of the hydraulic pressure used to fracture the formation. Particulates added in the blender, in turn, greatly affect the density of the slurry and, in fact, are the primary way of adjusting the slurry's density. Thus, it is essential that the density of the slurry being produced in the blender he carefully monitored to ensure that it is within specifications.

As noted, conventional blenders typically rely on radioactive densitometers because they are capable of measuring the density of liquids having entrained solids. In contrast, novel blender 100 preferably uses a liquid flow meter to infer the amount, that is the mass of liquid introduced into the slurry in combination with a microwave flow meter to infer the amount of solids introduced into the slurry. Measurements from those meters, along with known or measured separate densities of the liquid and solid phases, will allow determination of the density of the slurry delivered by blender 100. Readings will be made, and density determined, at predetermined time intervals via programmable logic controllers or other conventional digital computer systems to provide essentially real-time density data.

Conventional flow meters for liquids may be used, such as magnetic resonance and turbine flow meters, to provide a measurement of liquid flow into tub 41. Such meters measure the velocity of fluid flowing in the conduit from which, the dimensions of the conduit being known, the quantity of fluid flowing into tub 41 may be inferred. They are available commercially from a number of sources, such as NW-Lake Company, Oak Creek, Wis. (turbine flow meters), Badger Meter, Milwaukee, Wis. (turbine flow meters), Keyence Corporation of America, Itasca, Ill. (magnetic resonance flow meters), and Ludwig Krohne GmbH & Co. (Krohne Group), Duisburg, Germany (magnetic resonance flow meters). They will be installed in main suction line 33 between suction manifold 35 and tub 41. For example, as may be seen best in FIG. 4, a magnetic resonance flow meter 38 is mounted in main suction line 33.

Conventional microwave flow meters may be used to measure the amount of solids flowing into tub 41. The meters incorporate a microwave generator. Sensors in the meter detect microwaves reflected by moving particles. The quantity of moving particles then may be inferred by measuring the change in frequency and amplitude of the reflected microwaves. Typically, they will be calibrated by using a reference sample and flow rate. They are available commercially from a number of sources, such as Monitor Technologies LLC, DYNA Instruments GmbH, Hamburg, Germany, and Matsushima. Measure Tech Co., Ltd., Kitakyushu, Japan.

Microwave flow meters may be used to measure the flow rate of particles falling through air, carried in pneumatic lines or on conveyors, or flowing along chutes. Thus, they may be installed in a suitable housing proximate to the point where augers 52 drop solids into tub 41. In order to improve the accuracy of measurements, particulates should flow as uniformly as possible past the meter. Thus, the housing for the meter preferably will include guides designed to direct particulates in a predictable stream past the meter.

For example, solids system 50 incorporates discharge chute 53. As seen best in FIG. 9, chute 53 is mounted below augers 52 such that solids discharged from their ends will fall through the open top of chute 53. Opposing parallel walls 54a and tapered side walls 54b allow chute 53 to receive the solids and guide them as they continue their fall toward one of two outlet ducts 55. Chute 53 therefore, will encourage the solids to exit ducts 55 in two uniform flows. Microwave flow meters 56 (illustrated schematically) may be mounted on ducts 55. Flow meters 56, thus, are able to measure the amount of solids delivered into tub 41. It will be appreciated, of course, that the meter housing may be of any conventional design that is effective in creating a substantially uniform flow of particles across flow meters 56. Chutes having many different geometries and designs are known and may be used.

Solids system 50 also preferably includes vibrators to shake the particulates being conveyed into tub 41. For example, conventional vibrators may be mounted on the housing of augers 52 more or less at location 59 shown in FIGS. 2-3 or another suitable location. Alternately, vibrating guides may be employed to both shape and provide uniformity to the particulate flow. In any event, it will be appreciated that by using a combination of a flow meter to measure liquid flowing into tub 41 and a microwave flow meter to measure solids flowing into tub 41, the density of the slurry produced by blender 100 may be monitored and controlled without the need for a radioactive densitometer.

Flow rates of liquid and solids into tub 41 may be adjusted automatically by conventional control systems in response to density data. For example, the flow rate of liquid delivered to tub 41 may be controlled by varying the speed of suction pump 32. Alternately, a conventional automatically controlled flow control valve, such as butterfly valve 39 in main suction line 33, may be opened to varying degrees to adjust liquid flow. The flow rate of solids may be controlled, for example, by varying the speed of augers 52 pulling sand up from bin 51. Augers 52 also may discharge into a conventional automatic gravity flow metering device, such as a slide or roller gate valve, that can be opened to varying degrees. Suitable gravity flow metering devices are available commercially from a number of sources, such as Salina Vortex Corporation, Salina, Kans., and Kemutec Group, Inc., Bristol, Pa. Such components may be connected to the controller and operated automatically in response to density data through conventional motor controls to maintain a targeted density or to adjust the density on the fly.

As noted, solids flowing into mixing tub 41 can drag air along with it. The fluid will contain suspension agents to keep solids from settling, but the suspension agents also may cause air pulled into the slurry to become entrained for longer periods of time. Entrained air can damage centrifugal pumps, such as discharge pump 62, and can significantly affect the density of the slurry that will be pumped into the well. Thus, preferred embodiments of the novel blenders may comprise novel discharge chute 153.

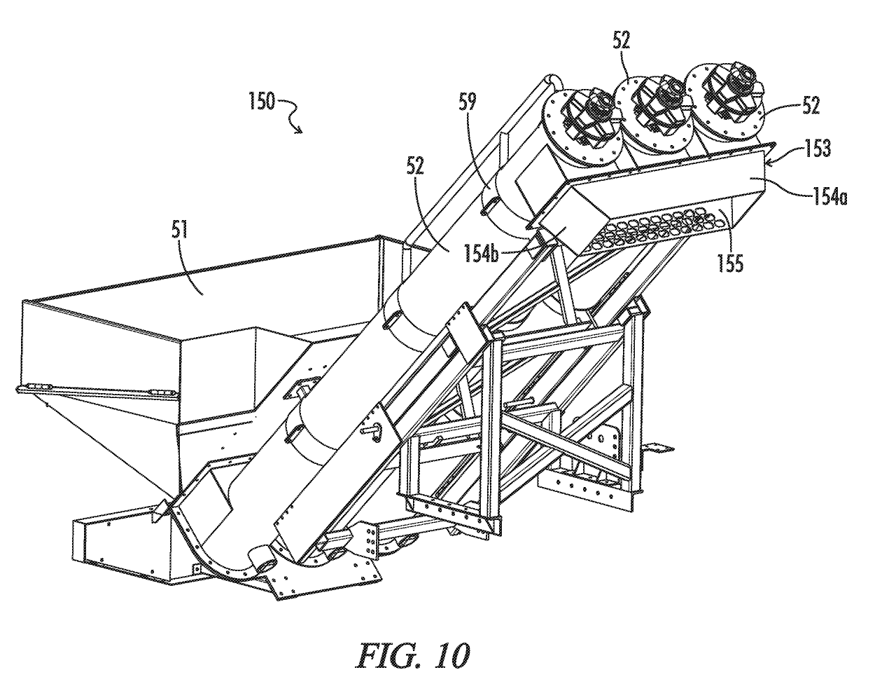

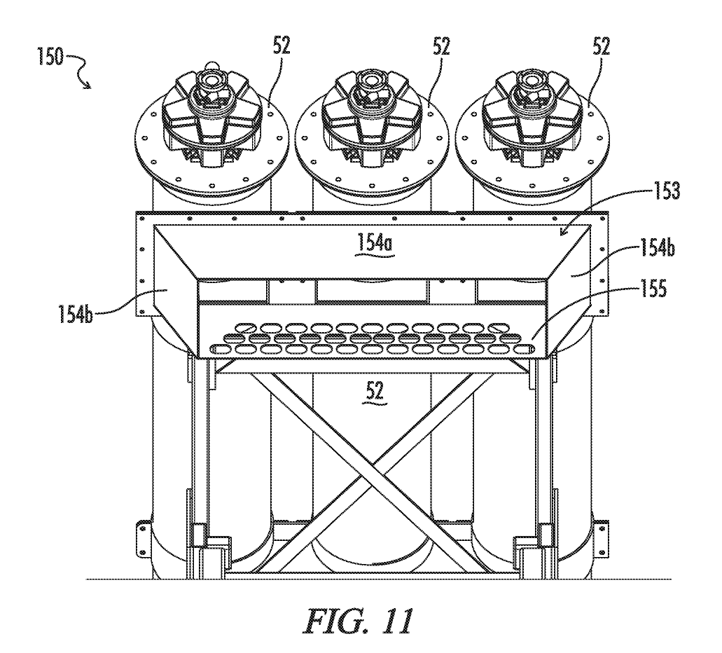

As may be seen in FIGS. 10-11, discharge chute 153 may be mounted below augers 52 such that solids discharged from their ends will fall through the open top of chute 153. In the absence of chute 153, it will be appreciated that the solids would fall from augers 52 into tub 41 in three relatively heavy streams, each of which could tend to drag significant quantities of air into the slurry. In contrast, opposing parallel wall 154a and baffle plate 155 and tapered side walls 154b of chute 153 will guide the discharge from augers 52 over baffle plate 155.

Baffle plate 155 is adapted to divide particulates discharged from augers 52 into a plurality of smaller streams. For example, baffle plate 155 may have a large number of relatively small openings. Baffle plate 155 as illustrated has 36 openings, but a suitable number can vary according to the expected discharge rates from the conveyor. By relatively small it will be appreciated that cumulatively the openings have the same or even greater flow capacity than the conveyor. Each individual opening, however, has a much smaller flow capacity, preferably at least an order of magnitude less, and more preferably at least 20 or 34 times less.

Preferably, as shown, the openings have an obround shape and are arranged in offset, linear arrays. The openings, however, may be circular, oval, rectangular, or any of many different shapes, and they may be arranged in many different patterns. Baffle plate 155 also preferably is mounted at an angle between vertical and horizontal, such as at approximately 45°. Particles falling on the upper portion of baffle plate 155 will fall downward across the face of plate 155 toward the openings. The arrays of openings will be situated at different elevations and will be offset in the horizontal plane. Thus, particulates sliding down baffle 155 will fall through the openings and be divided into much smaller, lighter streams that are far less likely to drag air into the slurry. Preferably, the particulates will be encouraged to divide into at least about 15, at least about 25, or at least about 35 smaller streams.

It will be appreciated, of course, that dividing discharge chute 153 may be modified in various ways. For example, baffle plate 155 may be oriented more or less horizontally and form a “bottom” of a tapered chute guiding particles onto baffle plate 155. More complicated baffles for dividing the stream are known and may be used. Baffle plate 155, however, is relatively easy to fabricate and effectively divides a much larger stream into many smaller streams.

Returning to discharge system 60, it will be noted that like suction bank 31, discharge bank 64 preferably comprises a dividing manifold 65 and numerous connections 66. Discharge connections 66, like suction connections 34, are hammer union subs which are assembled to manifold 65 by flanged butterfly valves 67. Also, like suction manifold 35, discharge manifold 65 comprises modular units 65a, 65b, and 65c which are joined by flange unions 68.

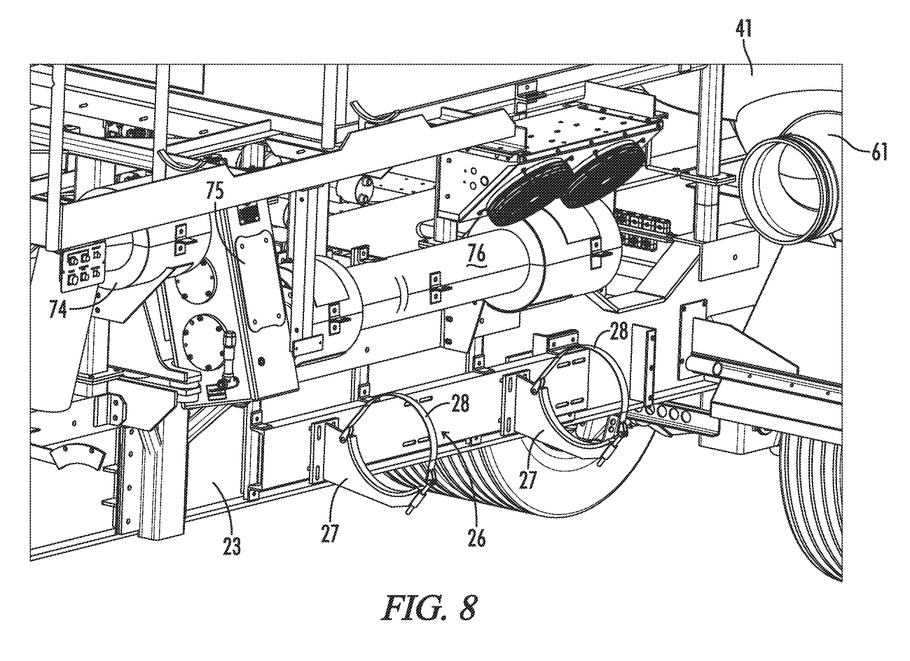

The discharge systems of the novel blenders, like the suction systems, may be mounted to a chassis in any conventional manner. Preferably, however, they also will be mounted and supported to allow some translation relative to the chassis. For example, blender 100 is provided with a mounting system 26 for discharge manifold 65 of discharge system 60. As seen best in FIG. 8, in which discharge system 60 has been removed, mounting system 26 is similar to mounting system 25 for suction manifold 35. Discharge manifold 65 is supported on cradles 27 like those in mounting system 25. Discharge manifold also may be secured by in cradles 27 by straps 28. It will be appreciated that main discharge line 63 preferably is mounted on a similar mounting system. Thus, similar tolerances may be provided in installing and repairing components of the discharge system 60 as are provided in suction system 34.

In addition, by using modular units, replacement of manifolds 35 and 65 is greatly facilitated, especially in the field. For example, it may be desirable to provide different banks 31 and 64 for different types of slurries. Banks 31 and 64 may be quickly and easily switched out for banks better suited for other slurries. There is no need to return to the shop for service or to bring an additional blender to the well.

It also will be appreciated that flow through both manifolds 35 and 65 is quite turbulent and is subject to sharp changes in direction. Unlike suction system 34, however, which handles essentially solid-free liquids, discharge system 60 handles large volumes of high-solids, highly abrasive slurry. Manifold 65, therefore, is subject to much greater erosion, especially in the upstream portion of manifold 65. Other factors being equal, module 65a of manifold 65 likely will be the first manifold component to suffer unacceptable erosion. Preferably, at least some of the manifold modules are identical, for example, modules 35a and 35b of manifold 35 and modules 65a and 65b of manifold 65 all are identical. Thus, modules from manifold 35 and modules from manifold 65 may be switched out to distribute wear more evenly throughout the system and to allow blender 100 to remain operational on site for longer periods of time.

It also will be appreciated that as the slurry drains from tub 41 into drain line 61, it will tend to form a vortex. Entrained air, and especially the formation of a vortex in liquid being pumped through a centrifugal pump, such as discharge pump 62, can significantly diminish its pump rates and damage the pump. Conventional blenders, therefore, typically incorporate one or more bars extending normally, that is, perpendicularly to the central axis of the drain line leading from the mixing tub. While such bars can reduce the tendency for a vortex to form in the drain line, they are subject to relatively rapid erosion, particularly at their junction with the inner walls of the drain line.

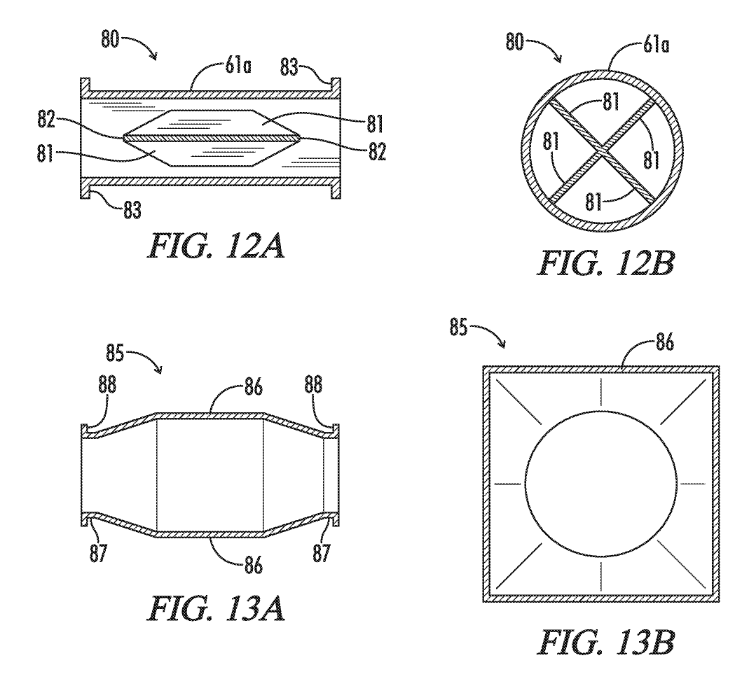

Thus, blender 100 preferably incorporates improved vortex breakers in drain line 61, such as vortex breakers 80 and 85 as shown in FIGS, 12-13. Breaker 80, as will be appreciated from FIG. 12, comprises what may be viewed as four fin members 81. Each fin member 81 is shaped like an isosceles trapezoid. Fin members 81 abut each other at their bases and project radially outward from the center of drain line 61. They are angularly arrayed at 90° intervals about an axis defined by their abutting bases. The tops of fins 81 are joined to the inner wall of drain line 61. Fin members 81 thus come to a point at each end 82, with one end 82 pointing upstream against the direction of flow of slurry through drain line 61. The other end 82 points downstream along the flow.

Breaker 80 preferably is mounted in a relatively short section of pipe 61a which may be assembled into drain line 61, for example, by flanges 83 provided at each end thereof. It is believed that breaker 80 will be subject to less erosion, particularly at the junction between fins 81 and the inner walls of drain line 61, than conventional breakers. It also will be appreciated that greater or fewer fins 81 may be provided in breaker 80, although typically three to six fins 81 will suffice. Likewise, the precise geometry of fins 81 may be varied. For example, the forward and rearward sweep of fins 81 may be varied and need not necessarily be linear. Likewise, ends 82 of tins 81 may be somewhat truncated.

Breaker 85, as will be appreciated from FIG. 13, has a rectilinear portion 86 disposed between cylindrical portions 87. Cylindrical portions 87 may be provided with, for example, flanges 88 on their ends to allow them to be assembled into drain line 61. Breaker 85, it is believed, will provide effective protection against the formation of vortexes in discharge pump 62, yet does not incorporated any cross-members that might be particularly susceptible to erosion.

It will be appreciated, of course, that breaker 85 may have other geometries and configurations and is not limited to the specific, illustrated design. For example, the length of rectilinear portion 86 may be varied, as may be the length and shape of the transition area between rectilinear portion 86 and cylindrical portions 87. The cross-section of rectilinear portion 86 also need not be square as illustrated. It may have other rectangular cross-sections, or even other polygonal cross-sections. Higher-order polygons, however, will tend to be less effective as they more closely approximate a circle.

Power system 70 serves primarily to power pumps 32, the mixing apparatus in tub 41, and the various control systems provided in blender 100. Power system 70 also typically drives electrical generators and includes alternators and storage batteries to power various control devices and systems. Otherwise, as best appreciated from FIGS. 3 and 6-8 showing the discharge side of blender 100, power system 70 generally includes a pair of diesel engines 71. One engine 71 drives a hydraulic pump (not shown) which in turn hydraulically drives suction pump 32 and the mixing apparatus in tub 41. The other engine 71 powers a drive train 72 which drives discharge pump 62. Drive train 72 includes a transmission 73 which is coupled to a first drive shaft 74. First drive shaft 74 is coupled to a gear box 75. Gear box 75 incorporates a plurality of mating gears which allow the rotation of drive shaft 74 to be increased as is typical of such gear boxes. A second drive shaft 76 is coupled to gear box 75 and ultimately drives discharge pump 62. (It will be appreciated that what are indicated in the figures as drive shafts 74 and 76 are actually the housings through which they pass.)

It will be appreciated that the gearbox of drive trains in conventional blenders typically is incorporated into, or otherwise coupled directly and rigidly to the transmission. That typically places severe space constraints on the gear box which can reduce its efficiency and decrease its service life. Moreover, when the clutch is released, and the engine operatively engages the drive train, conventional gear boxes can be subject to high mechanical shock created in overcoming inertia in the drive shaft and pump. The engine is operating at high rpms, the rotation of the engine is stepped up by the gear box, and there is a large, and essentially incompressible head of fluid in and above the pump. An elastomeric drive coupler typically is assembled between the gear box and drive shaft, but such couplers wear rapidly, must be changed often, and do not entirely absorb shock transmitted to the gear box.

In contrast, gear box 75 of blender 100 preferably, as seen best in FIGS. 7-8, is not coupled directly to transmission 73. It is connected to transmission 73 via first drive shaft 74, and then to discharge pump 62 via second drive shaft 76. Being removed from transmission 73, gear box 75 may be enlarged to accommodate a better gear design. Moreover, gear box 75 may be, and preferably is mounted to trailer 20 by shock absorbing mounts (not shown). The gear box mounts typically will incorporate hard rubber elastomer shock absorbers, and there are many conventional designs for engine mounts that may be used to mount gear box 75. In any event, the mounts will enable the entire gear box 75 to rotate in resistance as drive train 72 is engaged. The mounts will be able to absorb a large proportion of the torque created at engagement instead of having that force absorbed by the gears within gear box 75. It also is expected that they will be more durable than the elastomeric drive couplers used in conventional drive trains for blenders.

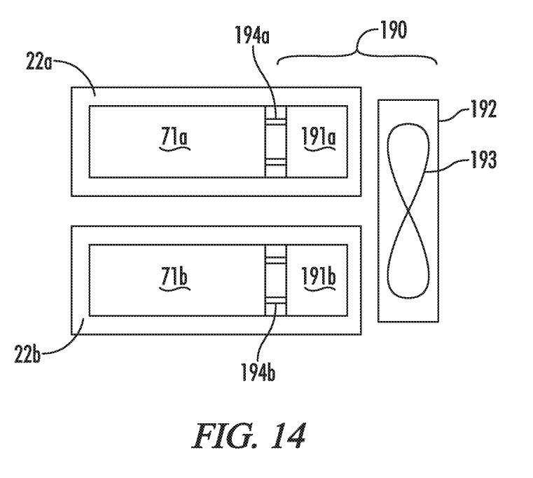

As generally shown in FIGS. 2-3, power system 70 of blender 100 comprises a conventional cooling system 90 for engines 71. More particularly, each engine 71 is provided with its own conventional radiator 91 and fan 93. Preferably, however, blender 100 will incorporate an improved cooling system 190 for engines 71. As shown schematically in FIG. 14, cooling system 190 comprises a pair of radiators 191 and a single air mover 192. Radiators 191 are of conventional design as are commonly employed in systems for circulating liquid coolant fluids through internal combustion engines. Heated coolant from each engine 71 is circulated into its associated radiator 191 by a pump driven by engine 71 where it is cooled prior to flowing back into engine 71. Air mover 192 includes one or more fans 193 mounted within various conventional shrouds and is designed to create and direct air flow across radiators 191. Air movers 192 also may be of conventional design. It will be noted in FIG. 14, however, that each engine 71 is connected via coolant lines 194 to its own radiator 191. A single air mover 192, however, directs air flow over both radiators 191. Air mover 192 may be mounted to either trailer 20, to radiators 191, to both, or in other conventional ways.

Thus, each engine 71 and its associated radiator 191 preferably, as shown schematically in FIG. 14, may be mounted on a common base or skid 22. In the event engine 71 requires service, therefore, air mover 192 first will be removed. Engine 71 and its associated radiator 191 then may be removed from trailer 20 as a unit. Conventional blenders typically include separate radiators and air movers for each engine, or they have a single air mover and a single radiator for both engines.

During a frac job, blender 100 will provide slurry for injection into a well. For example, as will be appreciated from FIG. 1, blender 100 may supply slurry to frac pumps 10 through low-pressure hoses 7 connected to low-pressure lines 8 in frac manifold 9, which in turn feed pumps 10 through suction hoses 11. Frac manifold 9 typically is not provided with a pump. Discharge pump 62 on blender 100 provides the pumping power to feed frac pumps 10.

Preferably, discharge pump 62 will be controlled to maintain a specified hydraulic pressure in hoses 7, low-pressure lines 8, and suction hoses 11, that is, between discharge pump 62 and the intakes of frac pumps 10. The specified pressure will correspond to the pressure head required by the frac pumps, that is, the hydraulic pressure that must be present at the intakes of the pumps to ensure that they operate properly. The pressure head is a more accurate way of measuring the fluid requirements of a pump. Flow rates are less reliable, as the pressure head at a specified flow rate will depend on the density of the fluid being pumped.

Accordingly, blender 100 may be provided with a pressure sensor (not shown), such as a pressure transducer. The pressure sensor is mounted downstream of discharge pump 62 in, for example, discharge line 63. Pressure readings will be made, and the speed of pump 62 will be adjusted to pump enough slurry to maintain the specified pressure. The sensor will be connected to a programmable logic controller or another conventional digital computer system which then will control the speed of discharge pump 62 by conventional control systems in response to the pressure data. It is expected that slurry will be delivered reliably to frac pumps 10, avoiding cavitation in frac pumps 10 while at the same time avoiding unnecessary wear on discharge pump 62.

The discharge pumps on conventional blender units typically are controlled to pump slurry at a specified flow rate. That is, an array of frac pumps will be determined to require a certain amount of a fluid over a certain amount of time, for example, 100 bbl/min. A meter in the discharge line of the blender unit will measure the flow rate from the discharge pump. The speed of the discharge pump then will be controlled to provide the specified flow rate.

If the frac pumps are speeded up during a fracturing operation, either intentionally or by accident, they will need more fluid to provide the required pressure head. The increased fluid requirements may exceed the specified flow rate. The blender, however, will continue to provide the specified flow rate, creating a risk that the frac pumps will not receive enough fluid and will cavitate. Cavitation can seriously damage the frac pumps. Consequently, operators of conventional blenders tend to set and keep the flow rate high, sometimes higher than specified, in an effort to ensure that the frac pumps always receive the required amount of slurry.

A problem arises, however, if frac pumps 10 are slowed down, either intentionally to reduce the pump rate into a well, or by inadvertence. An individual pump also may fail. The array of frac pumps then will require less slurry, causing pressure within the blender discharge lines to build, and flow rates to decrease. The discharge pump, however, will respond to decreased fluid flow by operating at high speed in an attempt to deliver the specified flow. Operating the discharge pump under such conditions can create considerable stress and wear on the pump.

It is expected that the novel blenders will be able to deliver slurry to frac pumps 10 at rates more accurately reflecting their requirements, and will reduce the risk of cavitation in frac pumps 10 while at the same time avoiding unnecessary wear on discharge pump 62. In the situations described above, if the fluid requirements of frac pumps 10 increase, novel blender 100 will detect a pressure drop. The speed of discharge pump 62 will be increased, thereby increasing the amount of slurry fed into frac pumps 10 and bringing the pressure head at pumps 10 back in line with their requirements. Conversely, if frac pumps 10 slow down, if their fluid requirements drop, blender 100 will detect a pressure increase and slow the speed of pump 62. Less fluid will be discharged, and discharge pump 62 will not be forced to operate at high speeds against an excessively high pressure head.

It also will be appreciated that conventional blenders where the discharge pump is controlled in response to flow rates cannot easily be adjusted to accommodate changes, expected or otherwise, in the density of slurry pumped from the blender. The pumps will be operated at the same speed regardless of the slurry density. In contrast, the novel blenders will be able to respond to changes in density. More dense slurries will increase the hydraulic pressure in the discharge line. Discharge pump 62 will be slowed accordingly to bring the pressure head at pumps 10 back in line with requirements. Likewise, discharge pump 62 will be sped up if slurry density decreases. Thus, the proper pressure head is maintained at frac pumps 10.

Blender 100 and its components, as well as other embodiments of the subject invention, may be manufactured by methods and from materials commonly used in manufacturing blenders. Many components are available commercially. Given the extreme stress and the corrosive and abrasive fluids to which the flowline components are exposed, suitable materials will be hard, strong, and durable, and typically will be steel, such as 4130 and 4140 chromoly steel or from somewhat harder, stronger steel such as 4130M7, high end nickel alloys, and stainless steel. The components may be made by any number of conventional techniques, but typically and in large part will be made by forging, extruding, or mold casting a blank part and then machining the required features into the part. Similarly, the engine and drive train components of the blenders will be manufactured or sourced for heavy duty service.

It also will be appreciated that blender 100 and other embodiments of the novel blenders, incorporate many different improvements in the systems conventionally incorporated into such equipment. Preferably, the novel blenders will incorporate all such improvements. At the same time, however, the invention encompasses embodiments where only one, or fewer than all such improvements are incorporated.

Similarly, the novel blenders have been described in the context of frac systems. While frac systems in particular and the oil and gas industry in general rely on blenders for mixing liquid and solid components, the novel blenders are not limited to such applications or industries. Suffice it to say that the novel blenders have wide applicability wherever there is a need to blend such components, and especially in the context of temporary fluid transportation systems.

While this invention has been disclosed and discussed primarily in terms of specific embodiments thereof, it is not intended to be limited thereto. Other modifications and embodiments will be apparent to the worker in the art.

1. A method of controlling the density of a slurry for injection into a well as said slurry is blended by a mobile blending apparatus, said slurry comprising particulates suspended in liquid; said method comprising:
(a) providing liquid having a known density to said blender;
(b) flowing said liquid through a conduit and discharging said liquid into a blending tub on said mobile blender;
(c) measuring the amount of liquid introduced into said tub with a liquid flow meter;
(d) providing solid particulates having a known density to said blender;
(e) discharging said particulates into said tub by allowing them to fall into said tub from a conveyor on said mobile blender; and
(f) measuring the amount of said particulates falling into said tub with a microwave flow meter;
(g) controlling the flow of said liquid and said particulates in response to said measurements to blend a slurry having a predetermined density; and
(h) providing said slurry for injection into said well.

2. The method of claim 1, wherein said liquid is measured using a magnetic resonance or turbine flow meter.

3. The method of claim 1, wherein said conveyor is a screw auger and the flow of said particulates is controlled by varying the speed of said auger.

4. The method of claim 1, wherein said conveyor discharges said particulates through a gravity flow metering device and the flow of said particulates is controlled by adjusting said device.

5. The method of claim 1, wherein said mobile blender comprises a centrifugal pump in said conduit and the flow of said liquid is controlled by varying the speed of said pump.

6. The method of claim 1, wherein said conduit comprises a flow control valve and the flow of said liquid is controlled by adjusting said valve.

7. A mobile apparatus for blending liquid and particulates into a slurry, said blender comprising:
(a) a chassis;
(b) a blending tub mounted on said chassis;
(c) a suction system adapted to discharge liquid into said tub, said suction system comprising a flow meter adapted to measure the flow of liquid through said suction system;
(d) a solids system adapted to discharge solid particulates into said tub, said solids system comprising a conveyor and a microwave flow meter adapted to measure the flow of said particulates discharged by said conveyor as said particulates fall into said tub; and
(e) a controller operatively connected to said suction system, said flow meter, said solids system, and said microwave flow meter and adapted to control the rate of liquid and solids discharged into said tub by, respectively, said suction system and said solids system in response to input from said liquid flow meter and said microwave flow meter to produce a slurry having a predetermined density.

8. The mobile blending apparatus of claim 7, wherein:
(a) said suction system comprises:
i) a suction line adapted to convey fluid into said tub; and
ii) a pump adapted to pump fluid through said suction line;
iii) wherein said flow meter is provided in said suction line; and
(b) wherein said controller is operatively connected to said pump and is adapted to control the rate of liquid discharged into said tub by controlling the speed of said pump.

9. The mobile blending apparatus of claim 7, wherein:
(a) said suction system comprises:
i) a suction line adapted to convey fluid into said tub;
ii) a pump adapted to pump fluid through said suction line; and
iii) a flow control valve;
iv) wherein said flow meter and said flow control valve are provided in said suction line; and
(b) wherein said controller is operatively connected to said flow control valve and is adapted to control the rate of liquid discharged into said tub by adjusting said flow control valve.

10. The mobile blending apparatus of claim 7, wherein said controller is operatively connected to said conveyor and is adapted to control the rate of solids discharged into said tub by controlling the speed of said conveyor.

11. The mobile blending apparatus of claim 7, wherein:
(a) said solids system comprises a gravity flow metering device adapted to receive the discharge from said conveyor; and
(b) said controller is operatively connected to said metering device and is adapted to control the rate of solids discharged into said tub by adjusting said metering device.

12. The blender of claim 7, wherein said solids system comprises a discharge chute having surfaces adapted to guide the flow of said particulates proximate to said microwave flow meter.

13. The blender of claim 12, wherein said chute is mounted below the discharge end of said conveyor and above said tub such that particulates discharged from said conveyor fall through said chute and into said tub.

14. The blender of claim 13, wherein said solids system comprises a plurality of said conveyors, said chute comprises an open receiving portion adapted to receive said particulates discharged by said plurality of conveyors and guide said particulates into a plurality of outlet ducts, and a said microwave flow meter is mounted in each said outlet duct.

15. (canceled)

16. (canceled)

17. A system for introducing solid particulates into a mixing tub on a mobile apparatus for blending liquid and particulates into a slurry, said solids system comprising:
(a) a supply bin;
(b) a conveyor mounted on said mobile blender and adapted to transport said particulates from a receiving end communicating with said supply bin to a discharge end elevated above said tub;
(c) a baffle mounted below said discharge end of said conveyor and above said tub such that particulates discharged from said conveyor fall on said baffle and then into said tub;
(d) said baffle adapted to divide said particulates into a plurality of streams.

18. The solids system of claim 17, wherein said baffle is a plate having a plurality of openings.

19. The solids system of claim 18, wherein said openings are obround.

20. The solids system of claim 18, wherein said openings are arranged in offset, linear arrays.

21. The solids system of claim 18, wherein said baffle comprises a plate mounted at an angle such that said openings are situated at a plurality of elevations and said particulates discharged onto said baffle plate are directed downward across said plate.

22. The solids system of claim 17, wherein said baffle comprises a chute mounted under said conveyor discharge end and having surfaces adapted to guide the flow of said particulates onto said baffle plate.

23. The solids system of claim 17, wherein said conveyor is a screw auger.

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)
